(19) United States
(12) Patent Application Publication
(10) Pub. No.: US 2017/0130511 A1
(43) Pub. Date: May 11, 2017

(54) DOOR SWINGING DEVICE

(71) Applicants: Richard Squires, Monument, CO (US); George Squires, Middleton, WI (US)

(72) Inventors: Richard Squires, Monument, CO (US); George Squires, Middleton, WI (US)

(21) Appl. No.: 14/935,825

(22) Filed: Nov. 9, 2015

(51) Int. Cl. E05F 15/77; F16M 13/02; E05F 15/63

(52) U.S. Cl. CPC E05F 15/77; E05F 15/63; F16M 13/02; E05Y 2400/654; E05Y 2400/66

(57) ABSTRACT

A door swinging device that does not require fastening to a door for installation or use. The door swinging device includes an actuator housing that slidably accepts an actuator therein. The actuator housing is attached to a door hook that is configured to hang from the top of a door. The actuator can be operably and physically attached to an arm, bracket and door frame. The door swinging device swings a door by pushing or pulling the door with respect to a door frame upon activation of the actuator. A frictional fit of the actuator in the actuator housing combined with a frictional fit of the door hook over the door maintains the actuator in a stable position with respect to the door during operation.

### FIELD OF THE INVENTION

The invention is directed to door swinging devices for horizontally swinging doors.

### BACKGROUND

Automatic door swinging devices are frequently used in commercial, industrial, and residential settings for power-operated opening and closing of doors. Automatic door swinging devices typically include a linkage assembly operably connecting a door to its frame. The linkage assembly is physically attached at one end to the door and at the other end to the door frame. The physical attachment of the linkage assembly, either to the door or the door frame, occurs via an actuator. Operation of the actuator pushes or pulls the door via the linkage assembly to close or open the door. See, e.g., U.S. Pat. No. 5,878,530; U.S. Pat. No. 6,634,140; U.S. Pat. No. 6,751,909; U.S. Pat. No. 7,600,345; and U.S. Pat. No. 8,844,200.

A drawback of conventional automatic door-swinging devices is that the physical attachment of the linkage assembly to the door, either directly or via an actuator, involves mounting with fasteners to provide a stable basis for counteracting the forces provided during operation. This permanently modifies and damages the door by leaving screw holes, etc., therein.

An automatic door swinging device that does not require modifying or damaging a door during installation and use is needed.

### SUMMARY OF THE INVENTION

The present invention provides door swinging devices that address the aforementioned need.

One version of a door swinging device of the invention comprises a door hook and an actuator attached to the door hook. The door hook comprises a first vertical piece and a horizontal piece. The horizontal piece is connected and substantially perpendicular to the first vertical piece. The door hook is configured to hang over a top of a door without substantially hindering closing of the door.

In some versions, the actuator housing comprises opposed converging vertical panels. The opposed converging vertical panels may comprise opposed converging vertical side panels. The side panels may converge as they extend distally from positions proximal the door hook.

In some versions, the actuator housing comprises a vertical side panel defining a slot to an interior cavity of the actuator housing. The slot may run an entire length of the side panel.

In some versions, the door hook further comprises a second vertical piece connected and substantially perpendicular to the horizontal piece, and the actuator housing connects to the door hook via the second vertical piece.

In some versions, the actuator housing comprises a first side panel, a front panel, a second side panel, a bottom panel, and a substantially open top. The second side panel in some versions is not directly connected to the door hook and is connected to the door hook via a panel selected from the group consisting of the first side panel, the front panel, and the bottom panel. The second side panel may define a slot between an edge of the second side panel and the door hook or a door on which the door hook is hung.

Some versions further comprise an actuator capable of being inserted in the actuator housing.

The actuator is preferably capable of being slidably inserted in a vertical dimension within the actuator housing in a configuration to resist rotational and horizontal translational movement of the actuator with respect to the actuator housing when a rotational or horizontal translational force is applied to the actuator. The actuator is preferably capable of resisting rotational and horizontal translational movement of the actuator with respect to the actuator housing when inserted in the actuator housing while still being capable of movement in a vertical dimension with respect to the actuator housing. The actuator is preferably capable of resisting rotational and horizontal translational movement of the actuator with respect to the actuator housing when inserted in the actuator housing without the actuator being fastened to the actuator housing.

In some versions, the actuator housing comprises a first side panel, a front panel, a second side panel, a bottom panel, and a substantially open top. The actuator and actuator housing are preferably configured for the actuator to sit on the bottom panel and slidingly but snugly fit in contact with at least one of the first side panel, the front panel, and the second side panel. The bottom panel of the actuator housing is preferably positioned to dispose at least a portion of the actuator above a horizontal plane defined by the horizontal portion of the door hook when the actuator sits on the bottom panel.

In some versions, the actuator comprises a light that illuminates when the actuator is in operation, and the actuator housing comprises a transparent window in register with the light when the actuator is inserted in the actuator housing.

In some versions, the actuator is a remote-controlled actuator.

In some versions, the actuator comprises an actuator body and an effector, is configured to move the effector with respect to the actuator body, and inserts within the actuator housing such that the actuator body resists rotational and horizontal translational movement with respect to the actuator housing when a rotational force is applied thereto while still being capable of moving in a vertical dimension with respect to the actuator housing. The device further comprises an arm connectable to the effector in a configuration for the effector to move the arm with respect to the actuator body when the effector is moved with respect to the actuator body. The device further comprises a bracket connectable to the arm and a door frame in a configuration for the arm to move with respect to the bracket and the door frame when the arm is moved with respect to the actuator body. Movement of the effector with respect to the actuator body swings the door with respect to the door frame when the actuator is inserted in the actuator housing, the arm is connected to the effector and the bracket, and the bracket is connected to the door frame.

In some versions, the actuator is a rotational actuator that rotates the effector with respect to the actuator body. The arm is a non-articulating arm with a first end of the arm connectable to the effector. The bracket comprises a track along which a second end of the arm is capable of moving translationally when the effector is rotated with respect to the actuator body.

The objects and advantages of the invention will appear more fully from the following detailed description of the preferred embodiment of the invention made in conjunction with the accompanying drawings.

### BRIEF DESCRIPTION OF THE DRAWINGS

FIGS. 1A and 1B depict side elevation views of an exemplary door swinging device of the present invention installed on a door and door frame. FIG. 1A shows the door in a closed position. FIG. 1B shows the door in an open position.

FIGS. 2-5 depict an exemplary door hook and attached actuator housing of the present invention. FIG. 2 shows a front perspective view. FIG. 3 shows a front elevation view, depicting a first vertical piece with dotted lines. FIG. 4 shows a top plan view, showing the bottom panel with dotted lines. FIG. 5 shows a side elevation view, showing the bottom panel with dotted lines.

### DETAILED DESCRIPTION OF THE INVENTION

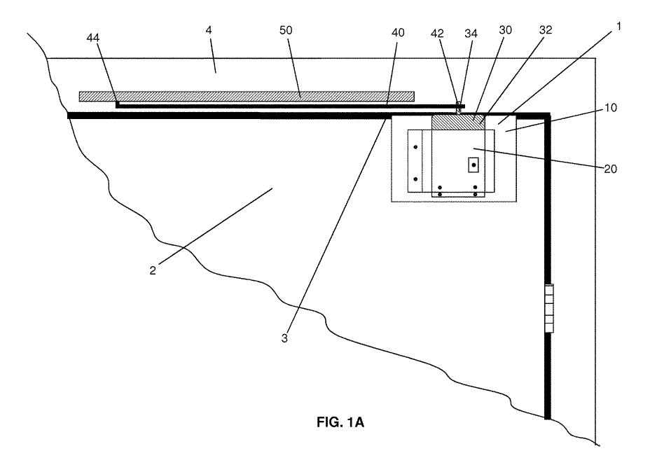

An exemplary version of a door swinging device 1 of the present invention is shown in FIGS. 1A and 1B. The device 1 includes a door hook 10 configured to stably hang over the top 3 of a horizontally swingable door 2, actuator housing 20 attached to the door hook 10, an actuator 30 slidably insertable within the actuator housing 20, an arm 40 connectable to the actuator 30, and a bracket 50 connectable to both the arm 40 and a door frame 4. The actuator 30 frictionally fits in the actuator housing 20 in a substantially secure manner that resists rotational and horizontal translational movement with respect to the actuator housing 20 when a rotational or horizontal translational force is applied to the actuator 30. Due to a substantially secure frictional fit of the door hook 10 on the door 2, the actuator 30 is in a substantially stable position both rotationally and translationally on the door 2. Actuation of the actuator 30 exerts a force on the door frame 4 via the arm 40 and bracket 50 to swing the door 2 either toward or away from the door frame 4.

The actuator 30 comprises an actuator body 32 and an effector 34. The actuator 30 is configured to move the effector 34 with respect to the actuator body 32 when the actuator 30 is actuated. The actuator 30 may be a rotational actuator or a translational actuator. A rotational actuator 30 rotates the effector 34 with respect to the actuator body 32. A translational actuator translates the effector 34 with respect to the actuator body 32. The exemplary actuator 30 shown in FIGS. 1A and 1B is a rotational actuator, wherein the effector 34 rotates with respect to the actuator body 32. If a translational actuator is used in place of the exemplary rotational actuator, the translational actuator preferably translates the effector 34 with respect to the actuator body 32 along an axis dimension substantially parallel to an axis defined by the top 3 of the door 2.

The arm 40 may be a non-articulating arm or an articulating arm. A non-articulating arm is a rigid arm that maintains a constant distance between a connection 42 of the arm 40 to the effector 34 and a connection 44 of the arm 40 to the bracket 50. An articulating arm permits the distance between the connection 42 to the effector 34 and the connection 44 to the bracket 50 to vary by virtue of, e.g., one or more pivots or hinges. The exemplary arm 40 shown in FIGS. 1A and 1B is a non-articulating arm.

The connection 42 between the arm 40 and the effector 34 and the connection 44 between the arm 40 and the bracket 50 may each independently take a variety of forms. Each connection 42,44 may be rotationally and translationally fixed, rotationally moveable but translationally fixed, or rotationally moveable and translationally moveable along only one of two perpendicular, horizontal dimensions. The configuration of each connection 42,44 depends on the configuration of the opposite connection 42,44 and the configuration of the arm 40. The connection 42 between the arm 40 and the effector 34 in the exemplary door swinging device 1 shown in FIGS. 1A and 1B is rotationally and translationally fixed. The connection 44 between the arm 40 and the bracket 50 in the exemplary door swinging device 1 shown in FIGS. 1A and 1B is rotationally moveable and translationally moveable along only one of two perpendicular, horizontal dimensions. Specifically, the connection 44 is moveable along a horizontal dimension parallel to a long axis defined by the top 3 of the door 2 and is substantially immoveable along a horizontal dimension perpendicular to the long axis defined by the top 3 of the door 2. Other possible configurations are discussed below.

The bracket 50 is configured to attach to the door frame 4 in a fixed manner. As used herein, “door frame” refers to any structure with respect to which the door is intended to be swung and may include, without limitation, a wall, trim or casing, a door jamb, a door stop, door head (header), and architrave, etc. The bracket 50 may attach to the door frame 4 using any fastener known in the art, including adhesive, screws, nails, bolts, etc.

The bracket 50 may take the form of any of a number of forms suitable for connecting the arm 40 to the door frame 4 including, without limitation, a clevis assembly, a hinge/pin assembly, a track, etc. The bracket 50 in the exemplary door swinging device 1 shown in FIGS. 1A and 1B is a track. The track is a longitudinally extended structure that permits a moveable connection along its longitudinal dimension but a substantially fixed connection in a horizontal dimension orthogonal to its longitudinal dimension. The track may or may not also provide a substantially fixed connection in a vertical dimension orthogonal to its longitudinal dimension. In one version, the track comprises an internal groove running at least a portion of the track's longitudinal dimension. The internal groove may be coordinately configured with an end portion of the arm 40 or a connector thereon such that the arm 40 or connector inserts within the groove in a rotationally and translationally moveable manner. Alternatively, the track may comprise a rail about which a coordinately configured end portion of the arm 40 or a connector on the end of the arm 40 clasps in a translationally moveable manner. These and other track configurations are well known in the art and need not be described in detail herein.

The actuator 30, arm 40, and bracket 50 in exemplary door swinging device 1 shown in FIGS. 1A and 1B cooperate to swing a door 2 as follows. Rotation of the effector 34 with respect to the actuator body 32 rotates the non-articulating arm 40 with respect to the door 2 by virtue of the rotationally and translationally fixed connection 42 between the arm 40 and the effector 34. By virtue of the connection 44 between the arm 40 and the bracket 50, rotation of the arm 40 either “pulls” or “pushes” against the bracket 50 in a horizontal dimension orthogonal to the longitudinal dimension of the bracket 50 while permitting rotation of the arm 40 within the bracket 50 and translation of the arm 40 along the longitudinal dimension of the bracket 50. The “pulling” or “pushing” of the arm against the bracket 50 effectively swings the door 2 toward or away, respectively, from the door frame 4.

The door swinging device of the invention may have any of a variety of alternative configurations. For example, an articulating arm may connect to the effector of a rotational actuator in a rotationally and translationally fixed manner and further connect to a bracket in a rotationally moveable but translationally fixed manner. Rotation of the arm by the actuator in this configuration articulates the arm, which thereby pushes or pulls the arm against the door frame while rotating the arm with respect to the bracket. In another configuration, an articulating arm may connect to the effector of a translational actuator in a rotationally moveable but translationally fixed manner and further connect to a bracket in a rotationally moveable but translationally fixed manner. Translation of the effector in this configuration articulates the arm and rotates the ends of the arm with respect to the effector and the bracket while pushing or pulling the arm against the door frame. Other configurations are encompassed by the present invention.

The ability of the actuator 30, arm 40, and bracket 50 to swing a door 2 as described above is dependent at least in part on the actuator 30 being capable of remaining in a substantially constant position with respect to the door 2 during operation. This in turn is dependent at least in part on the fit of the actuator 30 in the actuator housing 20 and the fit of the door hook 10 on the door 2.

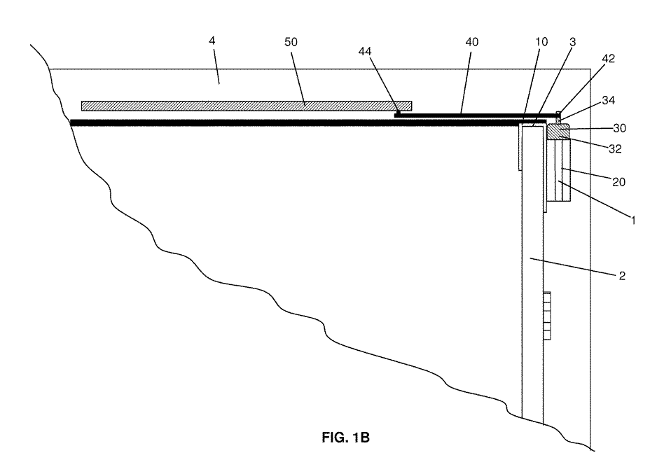

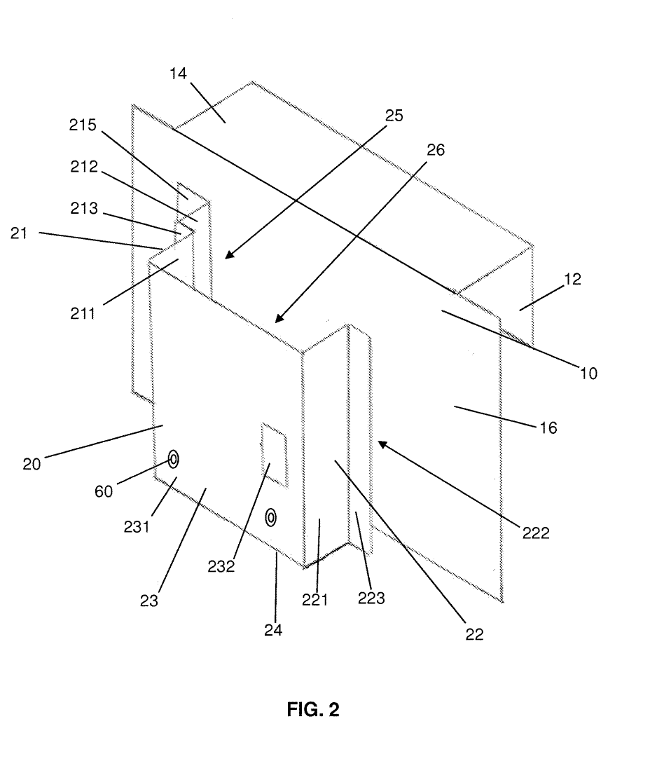

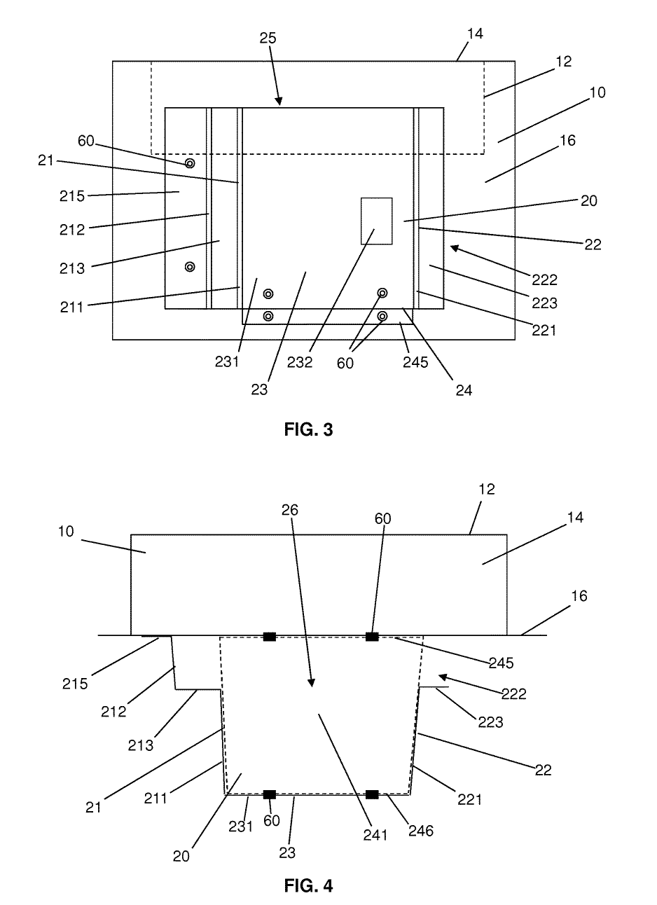

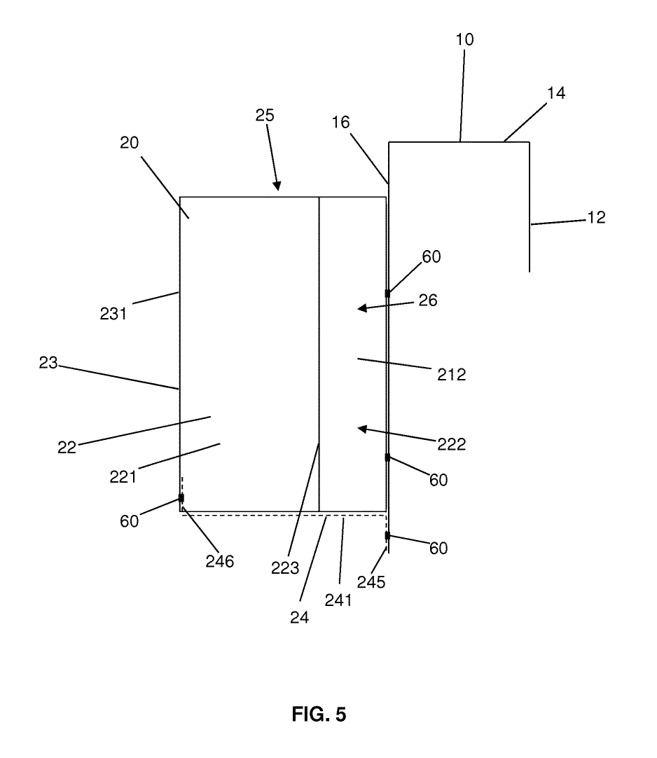

An exemplary door hook 10 and attached actuator housing 20 are shown in FIGS. 2-5.

The exemplary door hook 10 comprises a first vertical piece 12, a horizontal piece 14, and a second vertical piece 16. The first vertical piece 12, the horizontal piece 14, and the second vertical piece 16 in the exemplary door hook 10 each take the form of substantially planar panels. The first vertical piece 12 and the second vertical piece 16 are substantially parallel to each other and are each substantially perpendicular to the horizontal piece 14. The horizontal piece 14 directly or indirectly rests on the top 3 of the door 2 to vertically support the door hook 10 and actuator housing 20 thereon, the first vertical piece 12 and the second vertical piece 16 provide a compression pressure on opposite sides of the door 2 to resist translational or rotational movement of the door hook 10 and actuator housing 20 with respect to the door 2 without fastening the door hook 10, actuator 30, or actuator housing 20 to the door 2. The horizontal piece 14 is thin enough to fit between the top 3 of the door 2 and the door frame 4 to permit fitting over the top 3 of the door 2 while not substantially hindering closing of the door 2. The exemplary door hook 10 is formed from a single piece of resilient, semi-flexible material, such as metal or plastic, which is bent or molded into shape.

The first vertical piece 12 may be inwardly biased to frictionally engage the back surface of the door. The inward bias may be achieved by an attachment to the horizontal piece 14 at somewhat less than ninety degrees, such as 89 degrees, 88 degrees, 85 degrees, 80 degrees, etc. Such inward bias of the first vertical piece 12 is considered to be encompassed by the term “substantially perpendicular” used with respect to the horizontal piece 14.

The first vertical piece 12, the horizontal piece 14, and the second vertical piece 16 can take configurations other than substantially planar panels, such as non-planar bars, arms, lattices, etc., provided the horizontal piece 14 is capable of resting on the top 3 of the door 2 and the first vertical piece 12 is capable of exerting a pressure on a side of the door opposite the actuator housing 20.

In some versions, the door hook 10 does not comprise a second vertical piece 16, the actuator housing 20 is connected directly to the horizontal piece 14, and the actuator housing 20 and the first vertical piece 12 provide a compression pressure on opposite sides of the door 2.

One or more spacers may optionally be provided to fit between the first vertical piece 12 and the door 2 and/or between the second vertical piece 16 or actuator housing 20 (if a second vertical piece 16 is lacking) and the door 2. The spacers are preferably made from a slightly compressible material such as natural or synthetic rubber or plastics. The spacers close any potential gaps between the door hook 10 and the door 2 while increasing the friction between the door hook 10 and the door 2.

In an exemplary version of the door hook 10, the first vertical piece 12 has a height (vertical extension) of about 2 inches and a width (horizontal extension) of about 7.5 inches. The horizontal piece 14 has a width (horizontal extension along top 3 of door 2) of about 7.5 inches and a length (horizontal extension across top 3 of door 2) of about 2 inches. The second vertical piece 16 has a height (vertical extension) of about 6 inches and a width (horizontal extension) of about 9 inches. Each of the first vertical piece 12, the horizontal piece 14, and the second vertical piece 16 has a depth (thickness) of about 0.1 inches. The spacers can have a depth of about 0.05 inches to about 0.3 inches. For aesthetic purposes, the remaining dimensions of the spacers preferably match those of the components of the door hook 10 so they are substantially hidden by the door hook 10. These parameters are exemplary only and are not intended to be limiting.

The exemplary actuator housing 20 comprises a first side 21, a second side 22, a front side 23, a bottom side 24, an open top 25, and an inner cavity 26. The first side 21 comprises a first-side primary side panel 211, a first-side secondary side panel 212, a first-side intermediate flange 213 that connects the first-side primary side panel 211 and the first-side secondary side panel 212, and a first-side connecting flange 215 that connects the actuator housing 20 to the second vertical piece 16 of the door hook 10. The second side 22 of the actuator housing 20 comprises a second-side primary side panel 221, a second-side intermediate flange 223 connected to the second-side primary side panel 221, and an open side slot 222. The front side 23 comprises a front panel 231 and a transparent window 232 defined by the front panel 231. The bottom side 24 comprises a bottom panel 241, a bottom-side inner connecting flange 245 that connects the bottom panel 241 to the second vertical piece 16 of the door hook 10, and a bottom-side outer connecting flange 246 that connects the bottom panel 241 to the front panel 231.

The front panel 231, the first-side intermediate flange 213, the second-side intermediate flange 223, the first-side connecting flange 215, the bottom-side inner connecting flange 245, the bottom-side outer connecting flange 246, and the second vertical piece 16 of the door hook 10 are substantially parallel to each other and are substantially perpendicular to the first-side primary side panel 211, the second-side primary side panel 221, and the first-side secondary side panel 212. Conversely, the first-side primary side panel 211, the second-side primary side panel 221, and the first-side secondary side panel 212 are substantially parallel to each other and are substantially perpendicular to the front panel 231, the first-side intermediate flange 213, the second-side intermediate flange 223, the first-side connecting flange 215, the bottom-side inner connecting flange 245, the bottom-side outer connecting flange 246, and the second vertical piece 16 of the door hook 10. The bottom panel 241 is substantially perpendicular to all of the front panel 231, the first-side intermediate flange 213, the second-side intermediate flange 223, the first-side connecting flange 215, the bottom-side inner connecting flange 245, the bottom-side outer connecting flange 246, the second vertical piece 16 of the door hook 10, the first-side primary side panel 211, the second-side primary side panel 221, and the first-side secondary side panel 212.

The first-side primary side panel 211 is substantially opposed to the second-side primary side panel 221, and the first-side intermediate flange 213 is substantially opposed to the second-side intermediate flange 223. The first-side secondary side panel 212 and the first-side connecting flange 215 are substantially opposed by the open side slot 222. A second-side secondary side panel opposing the first-side secondary side panel 212 and a second-side connecting flange opposing the first-side connecting flange 215 may optionally be present, provided at least one open slot is defined elsewhere within the second side 22.

The exemplary actuator housing 20 is formed from two pieces of resilient, semi-flexible material, such as metal or plastic, which are each bent or molded into shape. A first piece forms the first-side connecting flange 215, the first-side secondary side panel 212, the first-side intermediate flange 213, first-side primary side panel 211, the front panel 231, the second-side primary side panel 221, and the second-side intermediate flange 223. A second piece forms the bottom-side inner connecting flange 245, the bottom panel 241, and the bottom-side outer connecting flange 246. The first-side connecting flange 215, the bottom-side inner connecting flange 245, and the bottom-side outer connecting flange 246 connect to the second vertical piece 16 of the door hook 10, the second vertical piece 16 of the door hook 10, and the front panel 231, respectively, via rivets 60 or other types of fasteners such as screws, bolts, adhesive, resins, etc.

The first-side primary side panel 211 and the second-side primary side panel 221 in the exemplary actuator housing 20 define a taper in the open top 25 and inner cavity 26 by converging toward each other as they extend from the door hook 10 to the front panel 231. This taper helps to provide a snug, slidable fit of the actuator 30 in the actuator housing 40, as discussed in further detail below. Alternatively or additionally, the first-side primary side panel 211 and the second-side primary side panel 221 may converge toward each other as they extend from the open top 25 to the bottom side 24 of the actuator housing 20. Alternatively or additionally, the front panel 231 may converge toward the door hook 10 as it extends from the open top 25 to the bottom side 24 of the actuator housing 20. The convergence of the panels may occur by being oriented at an angle of from 0.1° to about 5° with respect to each other, such as an angle of about 0.1°, 0.25°, 0.5°, 0.75°, 1°, 2.5°, 5°, or any range therebetween.

The actuator 30 and the actuator housing 20 are coordinately configured for the actuator 30 to slidably insert through the open top 25 and snugly fit in the actuator housing 20 in a manner for the actuator 30 to resist rotational and horizontal translational movement with respect to the actuator housing 20 when a rotational or horizontal translational force is applied to the actuator 30. Such resistance is capable of being provided by virtue of the snug fit of the actuator 30 in the actuator housing 20 without fastening the actuator 30 to the actuator housing 20 with a fastener. The snug, slidable fit is aided by a number of features of the actuator housing 20, such as the taper in the open top 25 and inner cavity 26 and the open side slot 222 on the second side 22. The taper provides for resistance as the actuator 30 is slid into the actuator housing 20. The open side slot 222 on the second side 22 provides for flexure of the actuator housing 20 to accommodate the actuator 30 as it is inserted therein. The actuator 30 and the actuator housing 20 are coordinately configured such that the actuator 30 makes a contact, preferably, with at least the first-side primary side panel 211 and the second-side primary side panel 221, and, more preferably, with the first-side primary side panel 211, the second-side primary side panel 221, the front panel 231, and the second vertical piece 16 of the door hook 10 (if present) or the door 2 (if a second vertical piece 16 is not present).

The bottom panel 241 preferably serves as a stop for the actuator 30 as the actuator 30 is inserted in the actuator housing 20. The bottom panel 241 is preferably positioned with respect to the horizontal piece 14 of the door hook 10 to position the effector 34 of the actuator 30 above the horizontal piece 14 when the actuator 30 is in contact with the bottom panel 241. This, in effect, positions the effector 34 above the top 3 of the door 2, providing clearance for the arm 40 to reach from the effector 34 to the door frame 4.

The actuator 30 is preferably an electrically powered actuator 30, and is more preferably a remote-controlled, electrically powered actuator 30. The actuator 30 may be battery powered or be powered by an electrical connection to a household outlet. In the latter case, the open side slot 222 provides access to the actuator 30 by power cords, etc. Electrical actuators 30 typically have lights or other signals that indicate when the actuator 30 is in operation. The transparent window 232 is preferably positioned in register with such lights so the lights are visible by a user during use. The transparent window 232 may comprise an open-air cutout in the front panel 231 or may comprise transparent glass, plastic, or other transparent material inserted in a cutout in the front panel 231. Alternatively or additionally, the transparent window 232 or open side slot 222 may be positioned in register with a sensor on the actuator 30 for the remote control.

The door swinging device 1 described herein provides a number of advantages over conventional door swinging devices. The device 1 can be easily installed on any existing door 2 without drilling or modifying the door 2. The symmetrical design of the actuator housing 20 and the slidable insertability of the actuator 30 therein allow for installation on left-hinged or right-hinged swinging doors 2 and also allow for easily changing the location of the actuator 30 on the door 2.

The terms used herein denoting positioning or orientation in space, or positioning or orientation with respect to another element, including but not limited to “vertical,” “horizontal,” “parallel,” “perpendicular,” and “orthogonal,” are understood to denote exactly or approximately having that positioning or orientation, unless the context requires otherwise.

The elements and method steps described herein can be used in any combination whether explicitly described or not.

All combinations of method steps as used herein can be performed in any order, unless otherwise specified or clearly implied to the contrary by the context in which the referenced combination is made.

As used herein, the singular forms “a,” “an,” and “the” include plural referents unless the content clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

It is understood that the invention is not confined to the particular construction and arrangement of parts herein illustrated and described, but embraces such modified forms thereof as come within the scope of the claims.

1. (canceled)

2. The device of claim 19, wherein the actuator housing comprises opposed, converging vertical panels.

3. The device of claim 19, wherein the actuator housing comprises opposed, converging vertical side panels.

4. The device of claim 3, wherein the side panels converge as they extend distally from positions proximal the door hook.

5. The device of claim 19, wherein the actuator housing comprises a vertical side panel defining a slot to an interior cavity of the actuator housing.

6. The device of claim 5, wherein the slot runs an entire length of the side panel.

7. The device of claim 19, wherein the door hook further comprises a second vertical piece connected and substantially perpendicular to the horizontal piece, wherein the actuator housing is connected to the door hook via the second vertical piece.

8. The device of claim 19, wherein the actuator housing comprises a first side panel, a front panel, a second side panel, a bottom panel, and a substantially open top.

9. The device of claim 8, wherein the second side panel is not directly connected to the door hook and is connected to the door hook via a pane selected from the group consisting of the first side panel, the front panel, and the bottom panel.

10. The device of claim 9, wherein the second side panel defines a slot between an edge of the second side panel and the door hook or a door on which the door hook is hung.

11. (canceled)

12. The device of claim 9, wherein the actuator is capable of being slidably inserted in a vertical dimension within the actuator housing in a configuration to resist rotational and horizontal translational movement of the actuator with respect to the actuator housing when a rotational or horizontal translational force is applied to the actuator.

13. (canceled)

14. The device of claim 19, wherein the actuator is capable of resisting rotational and horizontal translational movement of the actuator with respect to the actuator housing when inserted in the actuator housing without the actuator being fastened to the actuator housing.

15. The device of claim 19, wherein the actuator housing comprises a first side panel, a front panel, a second side panel, a bottom panel, and a substantially open top, wherein the actuator and actuator housing are configured for the actuator to sit on the bottom panel and slidingly but snugly fit in contact with at least one of the first side panel, the front panel, and the second side panel.

16. The device of claim 15, wherein the bottom panel of the actuator housing is positioned to dispose at least a portion of the actuator above a horizontal plane defined by the horizontal portion of the door hook when the actuator sits on the bottom panel.

17. The device of claim 19, wherein the actuator comprises a light that illuminates when the actuator is in operation, and wherein the actuator housing comprises a transparent window in register with the light when the actuator is inserted in the actuator housing.

18. The device of claim 19, wherein the actuator is a remote-controlled actuator.

19. A door swinging device comprising:
a door hook comprising a first vertical piece and a horizontal piece, the horizontal piece being connected and substantially perpendicular to the first vertical piece, the door hook being configured to hang over a top of a door without substantially hindering closing of the door;
an actuator housing attached to the door hook; and
an actuator capable of being inserted in the actuator housing, wherein:
the actuator comprises an actuator body and an effector, is configured to move the effector with respect to the actuator body, and inserts within the actuator housing such that the actuator body resists rotational and horizontal translational movement with respect to the actuator housing when a rotational force is applied thereto while still being capable of moving in a vertical dimension with respect to the actuator housing;
the device further comprises an arm connectable to the effector in a configuration for the effector to move the arm with respect to the actuator body when the effector is moved with respect to the actuator body;
the device further comprises a bracket connectable to the arm and a door frame in a configuration for the arm to move with respect to the bracket and the door frame when the arm is moved with respect to the actuator body, and
movement of the effector with respect to the actuator body swings the door with respect to the door frame when the actuator is inserted in the actuator housing, the arm is connected to the effector and the bracket, and the bracket is connected to the door frame.

20. The device of claim 19, wherein:
the actuator is a rotational actuator that rotates the effector with respect to the actuator body;
the arm is a non-articulating arm with a first end of the arm connectable to the effector; and
the bracket comprises a track along which a second end of the arm is capable of moving translationally when the effector is rotated with respect to the actuator body.

21. A door swinging device comprising:
a door hook comprising a first vertical piece and a horizontal piece, the horizontal piece being connected and substantially perpendicular to the first vertical piece, the door hook being configured to hang over a top of a door without substantially hindering closing of the door;
an actuator housing attached to the door hook;
an actuator capable of being inserted in the actuator housing, wherein the actuator:
comprises an actuator body and an effector;
is configured to move the effector with respect to the actuator body, and
is capable of being slidably inserted within the actuator housing such that the actuator body resists rotational and horizontal translational movement with respect to the actuator housing when a rotational force is applied thereto without the actuator being fastened to the actuator housing;
an arm connectable to the effector in a configuration for the effector to move the arm with respect to the actuator body when the effector is moved with respect to the actuator body; and
a bracket connectable to the arm and a door frame in a configuration for the arm to move with respect to the bracket and the door frame when the arm is moved with respect to the actuator body,
wherein movement of the effector with respect to the actuator body is capable of swinging the door with respect to the door frame when the actuator is inserted in the actuator housing, the arm is connected to the effector and the bracket, and the bracket is connected to the door frame.

22. The device of claim 21, wherein movement of the effector with respect to the actuator body is capable of swinging the door with respect to the door frame when the door hook is hung over a top of a door without being fastened to the door, the actuator is inserted in the actuator housing without being fastened to the actuator housing, the arm is connected to the effector and the bracket, and the bracket is connected to the door frame.

23. The device of claim 21, wherein the door hook is hung over a top of a door without being fastened to the door, the actuator is inserted in the actuator housing without being fastened to the actuator housing, the arm is connected to the effector and the bracket, and the bracket is connected to the door frame, wherein movement of the effector with respect to the actuator body swings the door with respect to the door frame.
